(19) United States
(12) Patent Application Publication
(10) Pub. No.: US 2007/0203791 A1
(43) Pub. Date: Aug. 30, 2007

(54) Management And Personalization Of Electronic Coupons In A Wireless Network

(75) Inventors: Omri Kohl, Tel Aviv (IL); Yuval Madar, Modiin (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: PDWAY LTD., Tel Aviv (IL)

(21) Appl. No.: 11/668,480

(22) Filed: Jan. 30, 2007

Related U.S. Application Data
(60) Provisional application No. 60/776,196, filed on Feb. 24, 2006.

(51) Int. Cl. G06Q 30/00

(52) U.S. Cl. 705/14

(57) ABSTRACT

A computerized method for presenting an electronic coupon to a user of a mobile telephone over a mobile telephone network. Activity of the user on the mobile telephone is monitored to obtain activity information. The activity information is processed to extract user data specific to the user. Based on the user data, an electronic coupon is selected for presenting to the user, the selection is from electronic coupons stored in a data base connected to a server application installed on a server connected to the network. The selected electronic coupon is then transmitted to and presented to the user on the mobile telephone. The monitoring is preferably performed by a client application installed on the mobile telephone and the activity information is transmitted to a server application running on the server. The user data is preferably stored in a user profile, and the user profile is updated based on the activity information to produce an updated user profile, and the selection is based on the updated user profile.

### CROSS REFERENCE TO RELATED APPLICATIONS

The present application claims the benefit from U.S. provisional application 60/776,196 filed 24 Feb. 2006 by the present inventors.

### FIELD AND BACKGROUND OF THE INVENTION

The present invention relates to the field of electronic coupons. More particularly, the invention is directed to the use of a data base of electronic coupons in which electronic coupons are managed by and personalized for a user of a wireless network

In retail marketing a coupon is a ticket or document that can be exchanged for a financial discount or rebate when purchasing a product. Coupons first came into widespread use in the United States in 1909, when C W Post came up with the idea to help sell breakfast cereals and other products. Customarily, coupons are issued by manufacturers of consumer packaged goods or by retailers, to be used in retail stores as a part of sales promotions. Coupons are often widely distributed through mail, magazines, newspapers and the Internet. Internet coupons have become very popular as of late, because the cost is borne by the user (who has to print the coupons themselves) rather than the businesses issuing the coupons.

Internet sites have coupons that can be used on line Examples of companies which provided on line coupons include Coolsavings (www.coolsavings.com), E-centives (www.ecentives.com) and Cataline Marketing International, Inc. (www.catalina-marketing.com). Several patents have been issued (e.g., U.S. Pat. Nos. 5,761,648; 6,321,208; and 6,584,448). These companies and others provide the capability of targeting and delivering on line print-at-home coupons, or coupons that are printed in-store, to motivate in-store sales. On line retailers usually refer to Internet coupons as “coupon codes,” “promotional codes,” “promotion codes,” “discount codes,” “key codes,” “promo codes,” “shopping codes,” “voucher codes” or “source codes.” Internet coupons typically provide for reduced or no cost shipping, a specific dollar or percentage discount, or some other special offer to encourage consumers to purchase specific products or to purchase from specific retailers. U.S. patent application publication 20060194569 discloses a process for delivering electronic coupons over a wireless network. A wireless network enables user registration, during which the user provides profile information, such as user name and address, etc, to an administration of the wireless network, such as at a Wifi hot spot location, the wireless network then associates the user with his/her profile information submitted during registration. The profile information is used to identify targeted or personalized electronic coupons for the user, and those targeted electronic coupons are transmitted to the user over the wireless network. The user selects one or more of the targeted electronic coupons, and transmits this selection over the wireless network to a dedicated server, which transmits a request to the user input a code, such as a mobile telephone number or an access code for a PDA, associated with the mobile communication device then being used by the user. Upon receipt of this code, the server within the wireless network, then transmits information associated with the selected electronic coupons to the mobile communication device associated with the inputted code. Such information, such as a unique coupon code and/or information summarizing the coupon and the goods or services to which it relates is sufficient to enable a store to clear the selected coupons during an in-store checkout procedure. U.S. Pat. No. 6,993,326, to Link et al discloses a method for transmitting advertisement coupons associated with respective advertisers over a wireless network to wireless communications devices. The wireless network is in communication with an advertisements database including advertisement coupons and a users database including identification data of wireless communications device operating in the wireless network. Advertisement coupons to be transmitted to the wireless communications device are stored in a pending database and, an advertisement coupon over a reverse control channel. The transmitted advertisement coupon is advertisement coupon in an account associated with the respective advertiser sponsoring the advertisement coupon.

### SUMMARY OF THE INVENTION

There is thus a need for, and it would be highly advantageous to have a method for managing electronic coupons on a mobile telephone, monitoring user activity using a client application and based on the user activity, update a user profile, score and select electronic coupons from a data base and present the selected electronic coupons on the mobile telephone for use by the user.

The term “point of sale” as used herein is a physical (such as in a store) not a virtual point of sale.

According to the present invention there is provided a computerized method for presenting an electronic coupon to a user of a mobile telephone over a mobile telephone network. Activity of the user on the mobile telephone is monitored to obtain activity information. The activity information is processed to extract user data specific to the user. Based on the user data, an electronic coupon is selected for presenting to the user. The selection is from electronic coupons stored in a data base connected to a server application installed on a server connected to the network. The selected electronic coupon is then transmitted to and presented to the user on the mobile telephone. The monitoring is preferably performed by a client application installed on the mobile telephone and the activity information is transmitted to a server application running on the server. The user data is preferably stored in a user profile; the user profile is updated based on the activity information to produce an updated user profile, and the selection is based on the updated user profile. The activity information includes redeeming the selected coupon such as by presenting a code associated with the selected electronic coupon at a point of sale. The activity includes the user accessing an electronic folder which includes a portion of the electronic coupons stored in the data base. The accessing includes: pulling an electronic coupon from the electronic folder by downloading the electronic coupon from the server to the mobile telephone; removing an electronic coupon from the electronic folder; and searching for an electronic coupon within the electronic folder. A location of the mobile telephone is preferably acquired and the selection is further based on the location.

According to the present invention there is provided a computer system which performs the method as disclosed herein. The computer system includes the client application installed on the mobile telephone with a Web interface which performs the monitoring and the server application which performs the processing, selects the electronic coupon and transmits the selected electronic coupon for presenting on the mobile telephone.

According to the present invention there is provided a computer readable medium, readable by the mobile telephone and/or the server attached to a mobile telephone network. A client application is installed on the mobile telephone. The computer readable medium tangibly embodies a program of instructions executable by the mobile telephone and/or the server to present the electronic coupon to a user of the mobile telephone over the mobile telephone network, according to the methods as disclosed herein.

According to the present invention there is provided a computer system in a wide-area wireless mobile network including a mobile telephone. A client application for managing electronic coupons is installed on the mobile telephone. The client application monitors user activity of a user of the mobile telephone. The user activity relates to the electronic coupons and produces activity information. A server application runs on a server connected to the wide-area wireless mobile network. The client application transmits the activity information to the server application. The server application processes the activity information to extract user data relevant to the user. Based on the user data, the server application selects an electronic coupon from the electronic coupons. The server transmits the selected electronic coupon to the client application for presenting to the user. The computer system, preferably includes an interface to a location providing service. The location providing service when available provides to the server a location of the mobile telephone. The server preferably selects the electronic coupon based on the location.

According to the present invention there is provided a computerized method for presenting an electronic coupon to a user of a computer over a computer network. Activity of the user on the computer is monitored to obtain activity information. The activity information is processed to extract user data specific to the user. Based on the user data, an electronic coupon is selected for presenting to the user. The selection is from electronic coupons stored in a data base connected to a server application installed on a server connected to the network. The selected electronic coupon is then transmitted to and presented to the user on the computer. The monitoring is preferably performed by a client application installed on the computer and the activity information is transmitted to a server application running on the server.

According to the present invention there is provided a computer system which performs the method as disclosed hereinabove, the system including a client application installed on the computer which performs the monitoring. The server application which processes the user data selects the electronic coupon and transmits the selected electronic coupon for presenting on the computer.

According to the present invention there is provided a computer readable medium readable by either the computer and/or the server attached to a computer network. The computer readable medium tangibly embodies a program of instructions executable by the computer and/or the server to present the electronic coupon to a user of the computer over the computer network according to a method as disclosed herein.

### BRIEF DESCRIPTION OF THE DRAWINGS

The invention is herein described, by way of example only, with reference to the accompanying drawings, wherein:

FIG. 1 is a drawing of a conventional wireless network including a wireless telephone with a display, according to an embodiment of the present invention;

FIG. 2 is a simplified system drawing according to an embodiment of the present invention;

FIG. 3 is a simplified process flow drawing according to an embodiment of the present invention; and

FIG. 4 is an illustration of different display layouts on a mobile telephone, according to an embodiment of the present invention.

### DESCRIPTION OF THE PREFERRED EMBODIMENTS

The present invention is of a system and method for providing coupons to a user. Specifically, the system includes a client application installed on a mobile telephone for management and use of electronic coupons. The client application dynamically monitors user activity, e.g. downloading, erasing, redeeming of coupons. A user profile is updated based on the user activity and coupons are selected for presenting to the user on the mobile telephone based on the user activity or on the updated user profile.

The principles and operation of a system and method of providing coupons to a user of a mobile telephone, according to the present invention, may be better understood with reference to the drawings and the accompanying description.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

The embodiments of the present invention may comprise a general-purpose or special-purpose computer system including various computer hardware components, which are discussed in greater detail below Embodiments within the scope of the present invention also include computer-readable media, for carrying or having computer-executable instructions, computer-readable instructions, or data structures stored thereon. Such computer-readable media may be any available media, which is accessible by a general-purpose or special-purpose computer system. By way of example, and not limitation, such computer-readable media can comprise physical storage media such as RAM, ROM, EPROM, CD-ROM or other optical disk storage, magnetic disk storage or other magnetic storage devices, or any other media which can be used to carry or store desired program code means in the form of computer-executable instructions, computer-readable instructions, or data structures and which may be accessed by a general-purpose or special-purpose computer system

In this description and in the following claims, a “network” is defined as any architecture where two or more computer systems, may exchange data. Exchanged data may be in the form of electrical signals that are meaningful to the two or more computer systems. When data is transferred or provided over a network or another communications connection (either hardwired, wireless, or a combination of hardwired or wireless) to a computer system or computer device, the connection is properly viewed as a computer-readable medium. Thus, any such connection is properly termed a computer-readable medium. Combinations of the above should also be included within the scope of computer-readable media. Computer-executable instructions comprise, for example, instructions and data which cause a general purpose computer system or special-purpose computer system to perform a certain function or group of functions.

In this description and in the following claims, a “computer” or “computer system” is defined as one or more software modules, one or more hardware modules, or combinations thereof, which work together to perform operations on electronic data. For example, the definition of computer system includes the hardware components of a personal computer, as well as software modules, such as the operating system of the personal computer. The physical layout of the modules is not important. A computer system may include one or more computers coupled via a computer network. Likewise, a computer system may include a single physical device (such as a mobile phone or Personal Digital Assistant “PDA”) where internal modules (such as a memory and processor) work together to perform operations on electronic data. In this description and in the following claims, a “server” is a computer attached to a network which performs a service by running a server application. A client is a computer or mobile telephone on which the service is performed.

Those skilled in the art will appreciate that the invention may be practiced in network computing environments with many types of computer system configurations, including mobile telephones, PDA's, pagers, hand-held devices, laptop computers, personal computers, multi-processor systems, microprocessor-based or programmable consumer electronics, network PCs, minicomputers, mainframe computers, and the like. The invention may also be practiced in distributed computing environments where local and remote computer systems, which are linked (either by hardwired links, wireless links, or by a combination of hardwired or wireless links) through a communication network, both perform tasks in a distributed computing environment, program modules may be located in both local and remote memory storage devices.

By way of introduction, principal intentions of the present invention include providing a client application to users of mobile telephones to manage and use electronic coupons. Management of coupons using the client application installed on the mobile telephone includes performing activities such as searching for electronic coupons by category or keyword, transferring to or removing from a personal electronic coupon folder, pulling (or downloading) electronic coupons from a general repository, and redeeming electronic coupons such as by performing a purchase at a point of sale. The activities of the user of the application are monitored and the user profile is dynamically updated by a personalization processing engine. Coupons are selected by the personalization engine based on the updated profile and/or recent user activity and are transmitted to and presented on the mobile telephone. In this way, users preferably receive and view coupons that they are most interested in. It should be noted that while the discussion herein is directed to a mobile telephone attached to a mobile telephone network, the principles of the present invention may be adapted for use in, and provide benefit for other computerized devices in other wired or wireless data networks

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

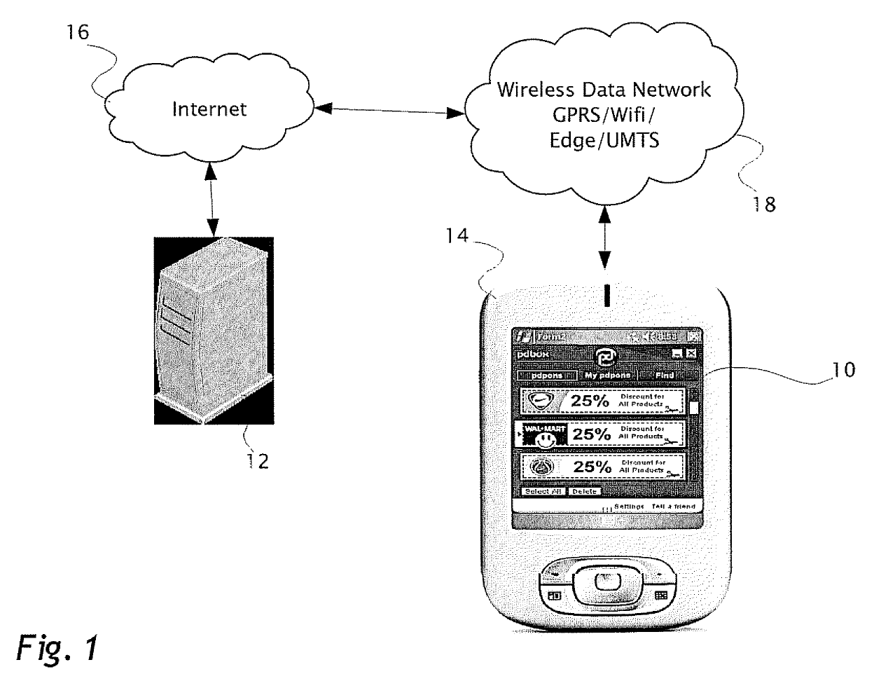

Referring now to the drawings, FIG. 1 illustrates, in accordance with embodiments of the present invention, a mobile telephone 14 connected to a server computer 12 by a wireless data network 18, e.g. GPRS and a wide area data network 16, e.g. Internet General Packet Radio Service (GPRS) is a mobile data service available to users of GSM and IS-136 mobile telephones.

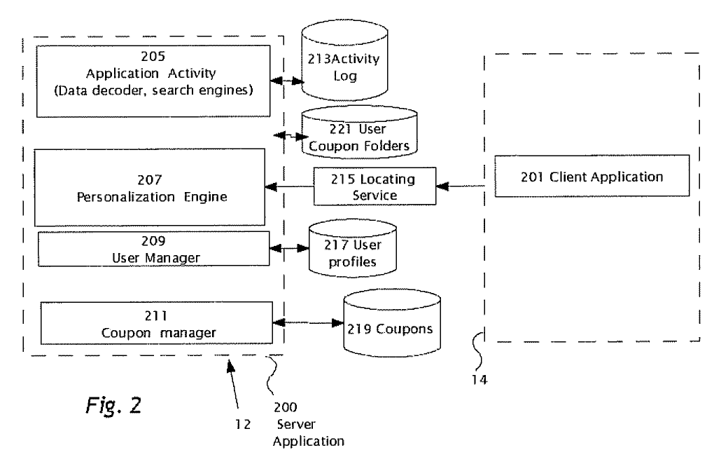

Reference is now also made to FIG. 2, a simplified block diagram, according to embodiments of the present invention. A server application 200 is installed on server 12. Server application 200 is attached to a repository 219 of electronic coupons. Creating, editing and removal of the electronic coupons from repository 219 are performed by a coupon manager 211. Typically, electronic coupons are created and stored using coupon manager 211 in repository 219 at the outset of an advertising campaign and are removed when the advertising campaign ends. Typically, a user interested in electronic coupons, registers with the service, and a client application 201 for receiving, managing and redeeming electronic coupons is installed on mobile telephone 14. The registration process is managed at server 12 by a user manager 209. Initial profile information is received from the user and stored as a user profile in user profiles storage 217.

Ron a new user of the electronic coupon service of the present invention has responded to a few questions and a new user profile was created for him. The user profile includes basic information such as age, marital status, education, occupation and hobbies. Ron is for instance single, college, educated and interested in sports. After registering, a client application is downloaded and installed on his mobile telephone 14. Ron opens client application 201 and finds in a home directory presented to him on display 10 (FIG. 1) three electronic coupons in a minimal format. One of the coupons is for 25% off on a vacation in the Bahamas. With no vacation time, left Ron deletes the vacation coupon. One coupon for sports shoes is of interest to him and Ron selects the sports shoes coupon and places the sport shoes coupon in his personal electronic coupons folder, as part of the service providing by the present invention.

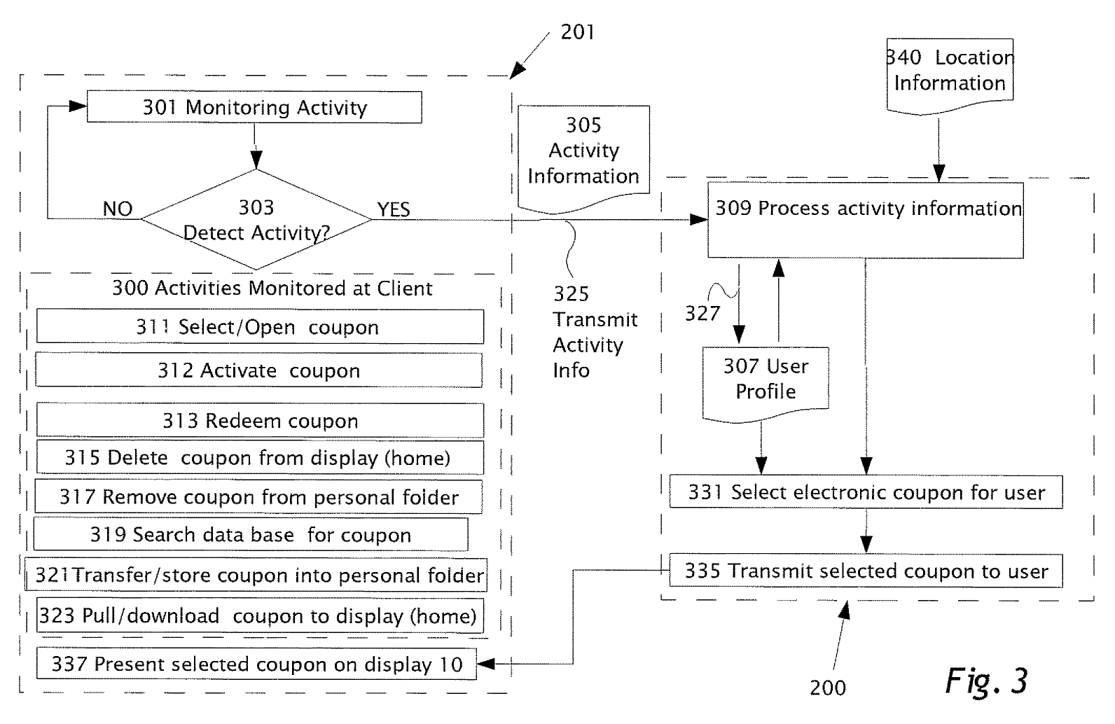

Reference is now also made to FIG. 3 a flow diagram illustrating a method according to embodiments of the present invention. Client application 201 is in communication with server application 200. Application activity module 205 of client application 201 monitors (step 301) activities 300 such as selection or opening (step 311) of electronic coupon, deletion (step 315), activate coupon (step 312), storage or transfer (step 321) to personal folder, removal (step 317) from the personal folder, search (step 319) of electronic coupons and pulling or downloading (step 323) to display 10 and/or redemption (step 313). When activity 300 is detected (decision box 303), activity information 305 is communicated to server application 200. For example, client application 201 detects (decision box 303) when Ron selects (step 311 the sports shoe coupon and transfers (step 321) it into his personal electronic coupon folder. At server 12, server application 200, for instance, places a reference (e.g. identification number) to the sports shoe coupon in a user coupon folders storage 221 in a folder registered specifically to Ron. In addition, activity information 305 is input to a personalization engine 207 which processes activity information (step 309) specific to one or more activities 300 detected (decision box 303) and updates (step 327) user profile 307 based on each of activities 300 detected. For example, when Ron deletes the vacation coupon, client application 201 detects (decision box 303) and transmits (step 325) to server application 200 an activity code 305 indicating deletion (step 315) with a coupon identifier, 305 of the deleted vacation coupon. Similarly when Ron selects (step 311) and stores (step 321) the sports shoe coupon in his personal folder, respective activity codes 305 indicating selection (step 311) and storing (step 321) of the sports shoe coupon are transmitted (step 325) with a coupon identifier 305 of the sports shoe coupon to server application 200. Activity information 305 is preferably stored in an activity log 213 by application activity module 205, processed (step 309) by personalization engine 207 and user profile 307 is updated (step 327) based on activity information (step 305). Alternatively, or in addition to updating (step 327) user profile, personalization engine 207 selects (step 331) different coupons for transmitting to (step 335) and displaying (step 337) based either on updated user profile 307 or based on activity information 305.

Coupons stored in repository 219 have specific properties and are categorized to allow the user to search (step 319) by category and sub-category and/or by keywords. The categorization and/or keywords of the coupons are typically also used for processing (step 309), updating (step 327) and selection (step 331). Typically, each activity 300 monitored (step 301) is assigned an activity value. Examples of activity values are found by way of example in the table below. A positive activity value is indicative of a coupon which is desired by the user and a negative value is indicative of a coupon not desired by the user. For example, redemption (step 313) is given the highest activity value, e.g. +1 of all monitored activities 300. Erasing (step 315) a coupon is given the lowest (largest negative absolute value), activity value e.g. −0.5.

For each user, user profiles 307 include coupon values for each (typically non-zero coupon values) of coupons according to category, sub-category and/or keyword. For example, when Ron deletes (step 315) the vacation coupon, respective coupon values for each vacation coupon in repository 219 were reduced (by processing step 309) in Ron's user profile 307 by activity value 0.5 (i.e. −0.5 is added to current coupon value). If Ron activates (step 312) the sports shoe coupon, respective coupon values in Ron's activity profile 307 of other sports shoe coupons stored in repository 219 are increased (by processing step 309) by value 0.5. Selection (step 331) is based on the coupon point values in user profile 307, the coupons with the highest coupon values are presented on display 10.

| Type of activity 300 | Point Value |
|---|---|
| Transfer to personal folder (step 321) | 0.34 |
| Search category tree (step 319) | 0.34 |
| Keyword search (step 319) | 0.2 |
| Open coupon (step 311) | 0.2 |
| Activate coupon (step 312) | 0.5 |
| Redeem coupon (step 313) | 1 |
| Erase coupon (step 315) | −0.5 |

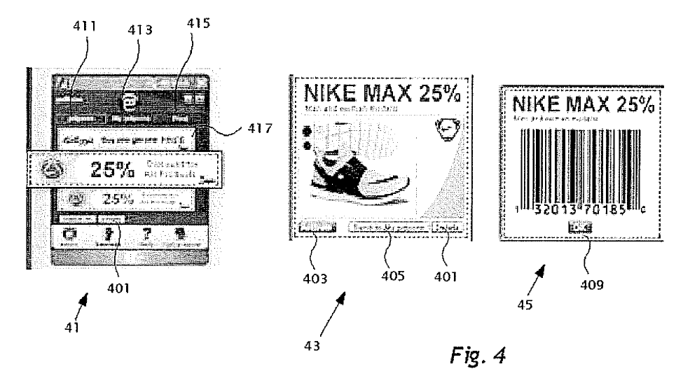

According to embodiments of the present invention, electronic coupons have different states FIG. 4 illustrates three different layouts as presented on display 10 for three different states for an electronic coupon. Typically, an electronic coupon is initially displayed as a preview 417. Typically tabs or other input mechanisms are available such as a search tab 415 for performing searches (step 319), a tab 413 for entering personal electronic coupons folder and a home tab 411 for returning to the display of coupons. A delete button 401 may be used to delete displayed preview 417. Once selected, a second click on the selected coupon may be used to open the coupon (step 311) into an advertisement layout 43 in which more detailed information is presented than is presented in preview 417. The user may choose a delete button 401 to delete the displayed advertisement layout from the display, transfer (step 321) the displayed coupon to the personal electronic coupon folder and/or activate (step 312) the displayed coupon. Activation (step 312) typically brings up a bar code layout 45 or encoded bar code number. Button 409 is optionally used for redeeming (step 313) the electronic coupon. Typically, the bar code is scanned at a point of sale and button 409 is used for initiating the transaction and closing layout 45.

Reference is now made again to FIGS. 2 and 3. Often, mobile network 18 is connected to a locating service 215 used to provide location information 340 of mobile telephone 14 to the user or to location based services. Various methods are known in the prior art for locating mobile telephones 14 and providing location information 340 of mobile telephones 14. According to an embodiment of the present invention, location information 340 is provided as an input to personalization engine 207. Location information 340 is optionally used to select (step 331) an electronic coupon for presenting 337 to the user. As an example, when Ron is walking, locating service 215 provides location information 340 of Ron being near a Walmarts store. Personalization engine 207 upon processing location information 340 selects an electronic coupon of interest to Ron based on user profile 307 and redeemable in Walmarts for instance, 25% on Nike sports shoes.

While the invention has been described with respect to a limited number of embodiments, it will be appreciated that many variations, modifications and other applications of the invention may be made.

What is claimed is:

1. A computerized method for presenting at least one electronic coupon to a user of a mobile telephone over a mobile telephone network, the method comprising the steps of:
(a) monitoring activity of the user on the mobile telephone, thereby obtaining activity information;
(b) processing said activity information thereby extracting user data specific to the user;
(c) based on said user data, selecting at least one selected electronic coupon for the presenting to the user, said selecting from a plurality of electronic coupons stored in a data base operatively connected to a server application installed on a server operatively connected to the network; and
(d) the presenting the at least one selected electronic coupon to the user.

2. The computerized method, according to claim 1, wherein said monitoring is performed by a client application installed on the mobile telephone, further comprising the step of:
(e) transmitting said activity information to a server application running on said server.

3. The computerized method, according to claim 1, further comprising the steps of:
(e) storing said user data in a user profile of the user; and
(f) updating said user profile based on said activity information, thereby producing an updated user profile, wherein said selecting is based on said updated user profile.

4. The computerized method, according to claim 1, wherein said activity includes the step of:
(e) redeeming the at least one selected coupon;

5. The computerized method, according to claim 1, wherein said activity includes the step of:
(e) redeeming the at least one selected coupon by presenting a code associated with the at least one selected electronic coupon at a point of sale

6. The computerized method, according to claim 1, wherein said activity includes the step of:
(e) accessing by the user an electronic folder, said electronic folder including at least a portion of the electronic coupons

7. The computerized method, according to claim 6, wherein said accessing includes pulling at least one of said electronic coupons from said electronic folder by downloading from the server to the mobile telephone.

8. The computerized method, according to claim 6, wherein said accessing includes removing at least one of said electronic coupons from said electronic folder.

9. The computerized method, according to claim 6, wherein said accessing includes searching for at least one of said electronic coupons within said electronic folder.

10. The computerized method, according to claim 1, further comprising the step of:
(f) acquiring a location of the mobile telephone, wherein said selecting is further based on said location.

11. A computer system which performs the method according to claim 1, the computer system comprising:
(a) a client application installed on the mobile telephone which performs said monitoring; and
(b) said server application which performs said processing, said selecting of the at least one electronic coupon and transmitting said at least one selected electronic coupon for the presenting on the mobile telephone.

12. A computer readable medium readable by at least one machine attached to a mobile telephone network, the at least one machine selected from the group consisting of the mobile telephone and the server of claim 1, wherein a client application is installed on the mobile telephone, the computer readable medium tangibly embodying a program of instructions executable by the at least one machine to present the at least one electronic coupon to a user of the mobile telephone over the mobile telephone network, according to the method steps of claim 1.

13. In a wide-area wireless mobile network including a mobile telephone, a computer system comprising:
(a) a client application for managing a plurality of electronic coupons, said client application installed on the mobile telephone, wherein said client application monitors user activity of a user of the mobile telephone, said user activity related to said electronic coupons and producing thereby activity information; and
(b) a server application running on a server operatively connected to the wide-area wireless mobile network, wherein said client application transmits said activity information to the server application, said server application processing said activity information thereby extracting user data relevant to said user, wherein based on said user data, said server application selects at least one selected electronic coupon from said electronic coupons, wherein said server transmits said at least one selected electronic coupon to said client application for presenting to the user.

14. The computer system, according to claim 13, further comprising:
(c) an interface to a location providing service, wherein said location providing service provides to said server a location of the mobile telephone, wherein said server selects said at least one selected electronic coupon based on said location

15. A computerized method for providing at least one electronic coupon to a user of a computer over a computer network, the method comprising the steps of:
(a) monitoring activity of the user on the computer, thereby obtaining activity information;
(b) processing said activity information thereby extracting user data specific to the user;
(c) based on said user data, selecting at least one selected electronic coupon for presenting to the user, said selecting from a plurality of electronic coupons stored in data base operatively connected to a server application installed on a server operatively connected to the network; and
(d) presenting the at least one selected electronic coupon to the user.

16. A computer system which performs the method according to claim 15, the system comprising:
(a) a client application installed on the computer which performs said monitoring; and
(b) said server application which performs said processing, said selecting of at least one electronic coupon and transmitting said at least one selected electronic on for said presenting on the computer.

17. A computer readable medium readable by at least one machine attached to a computer network, the at least one machine selected from the group consisting of the computer and the server of claim 15, wherein a client application is installed on the computer, the computer readable medium tangibly embodying a program of instructions executable by the at least one machine to present the at least one electronic coupon to a user of the computer over the computer network, according to the method steps of claim 15.
